(19) United States
(12) Patent Application Publication
(10) Pub. No.: US 2010/0156934 A1
(43) Pub. Date: Jun. 24, 2010

(54) Video Display Controller

(76) Inventors: Wujian Zhang, Santa Clara, CA (US); Alok Mathur, Milpitas, CA (US); Sreenath Kurupati, Sunnyvale, CA (US); Dmitrii Loukianov, Chandler, AZ (US); Peter Munguia, Chandler, AZ (US)

Correspondence Address: TROP, PRUNER & HU, P.C., 1616 S. VOSS RD., SUITE 750, HOUSTON, TX, 77057-2631, US

(21) Appl. No.: 12/342,375

(22) Filed: Dec. 23, 2008

(51) Int. Cl. G09G 5/00

(52) U.S. Cl. 345/629

(57) ABSTRACT

A video display controller may be implemented by a plurality of identical hardware blend stages that can be coupled together to produce the desired blend of video, graphics, overlays, and the like. Each of the various video planes to be blended can be multiplied by an alpha value to selectively apply alpha values to particular video planes. At least two video display windows may be selectively produced by the coupled blend stages.

### BACKGROUND

This relates generally to video display controllers that control video displays. A video display controller handles the merging and blending of various display planes.

The final picture on a display screen may consist of various content types. In addition, the final display may include one, two, or more video display windows, menus, television guides, closed captioned text, volume bars, channel numbers, and other overlays. Each of these display content types are rendered separately and merged or blended with others in the video display controller.

### BRIEF DESCRIPTION OF THE DRAWINGS

FIG. 1 is a schematic depiction of one embodiment of the present invention;

FIG. 2 is a more detailed schematic depiction of a video display controller in accordance with one embodiment; and

FIG. 3 is a still more detailed schematic depiction of a blend stage, shown in FIG. 2, in accordance with one embodiment.

### DETAILED DESCRIPTION

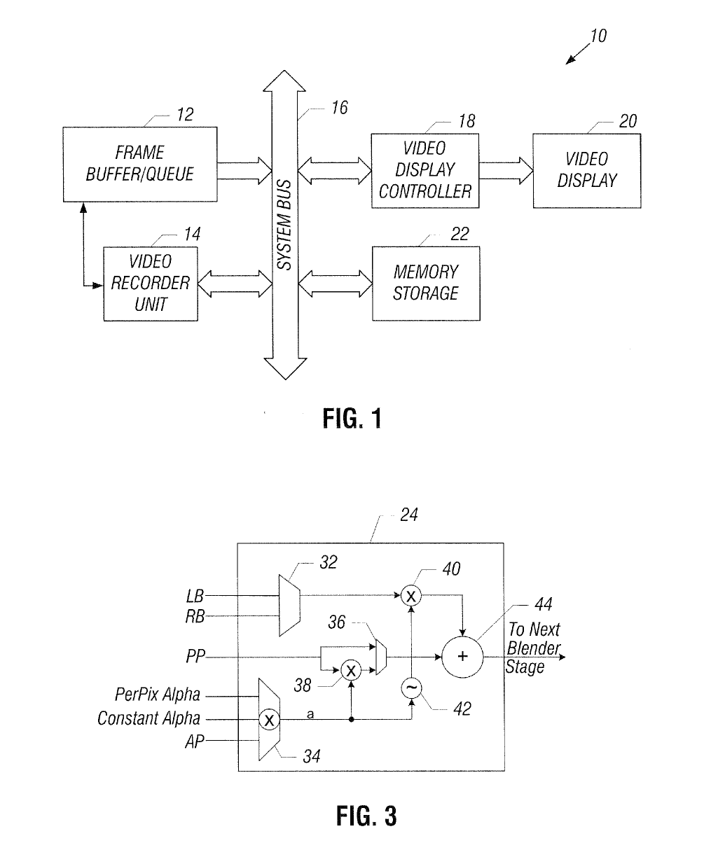

Referring to FIG. 1, a video display system 10 which may for example be part of a digital camera, a media system, a television, a projector, a video recorder, or a set top box, to mention a few example. The system 10 may include a frame buffer/queue 12 coupled to a system bus 16. The frame buffer/queue may be coupled to a video decoder unit 14, also coupled to the system bus 16.

A video display controller 18 receives video content from various sources and blends and merges it for display on a video display 20. The video display 20 can be any type of video display, including a television.

A memory storage 22 is also coupled to the system bus 16.

Video data sources may be coupled to the system bus 16. The video data may be received from a media player, from a broadcast source, from a cable source, or from a network, to mention a few examples.

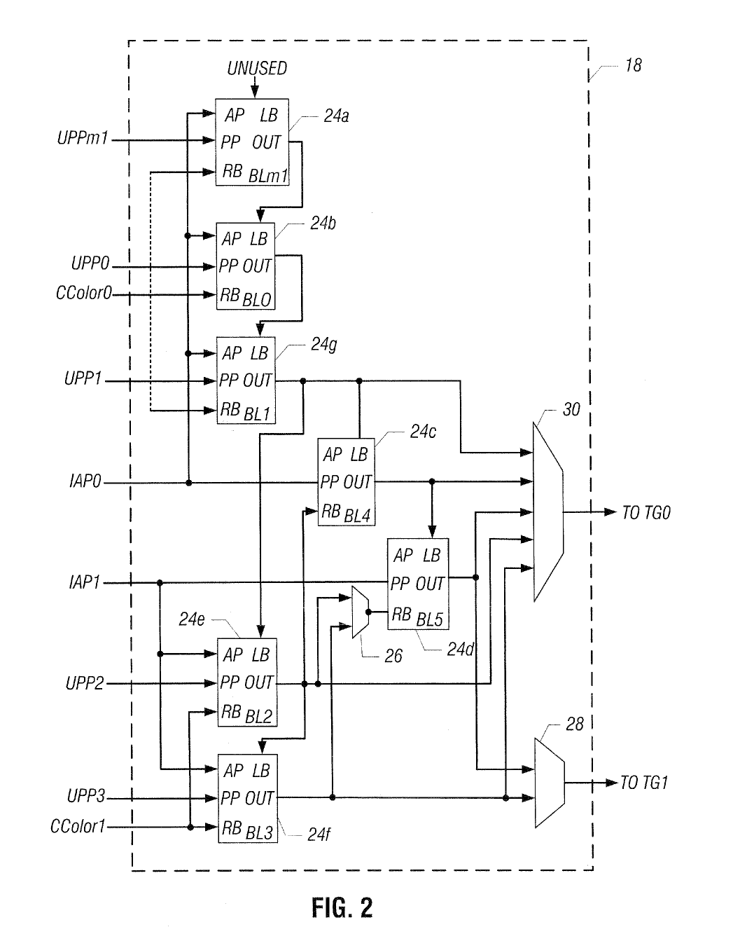

Referring to FIG. 2, in accordance with one embodiment, the video display controller 18 may include a plurality of identical blend stages 24a-f, coupled together by multiplexers 26, 28, and 30. Each blend stage 24 can receive video from a universal pixel plane (UPP) or an index-alpha plane (IAP). Video or graphics content is processed through the universal pixel plane, while subtitle, cursor, or alpha content is received through the indexed-alpha plane. By using multiple identical blend stages 24, in one embodiment, a modular architecture may be achieved that can be reused in different configurations.

Each stage has the flexibility to choose the relevant two pixels to be blended and their alpha values. In one embodiment, one of the pixels is always received directly from an attached plane. The previous source pixel is selectable from two other sources called either left blender out or right blender out.

Thus, in the embodiment shown in FIG. 2, the blend stage 24a receives an input through the pixel pipe (PP) and an input from the universal pixel plane M1. It receives no left blender out (LB) input. The alpha pipe (AP) receives an input from the index-alpha plane 0, while the right blender output (RB) is coupled to canvas or background color (CColor0). CColor0 and CColor1 are programmable constants that represent the canvas color, i.e., the background color (the lowest layer) of the whole blending picture.

The output from the blend stage 24a is provided to the left blender out of the next stage 24b. The next stage also receives the alpha pipe and right blender out in the same way as the previous stage. The pixel pipe is connected to the universal pixel plane 0 and the output of the blend stage 24b is coupled to the next blend stage 24g. It is connected to receive the same right blender out and alpha pipe input as the previous stages. Its pixel pipe input is provided from the universal pixel pipe 1. Its output goes to a multiplexer 30 that goes to a first output window TG0. That output also goes to the next blend stage 24e and on other blend stage 24c.

The blend stage 24c receives its pixel plane data from the index-alpha plane 0. The right blender out comes from the blend stage 24e and the output is provided both to the multiplexer 30 and the blend stage 24d.

The blend stage 24e receives its alpha pipe input from index-alpha plane 1. The pixel pipe input is received from the universal pixel plane 2 and the right blender out comes from CColor1. The output is provided to the multiplexer 26 and to the multiplexer 30.

The blend stage 24f has an output connected to the multiplexer 28, which may provide the second video window TG1. The right blender out is connected to CColor1. The input pixel pipe is connected to universal pixel plane 3. The alpha pipe is coupled to the index-alpha plane 1. The output from the blend stage 24f goes to the multiplexer 28 and the multiplexer 26 for selective display in either the window TG0 or the window TG1.

The processing in each blend stage 24 and its hardware may be the same, with only the inputs being different. Thus, as shown in FIG. 3, the multiplexer 32 selectively outputs one of the left blender out (LB) or the right blender out (RB) which goes to a multiplier 40. The multiplier 40 may multiply by an alpha value selected by a multiplexer 34, adjusted by a stage 42. The alpha value basically adjusts the transparency of one video plane relative to another. The pixel pipe information can be provided to another multiplier 38 if it is not already alpha value adjusted, otherwise it is provided directly for selection by a multiplexer 36 from which it is output to an adder 44. The adder 44 adds the pixel pipe information, plus the selected left blender out or right blender out, adjusted, as needed, with the alpha value.

The blending operation basically uses the alpha value to adjust the relative transparency between two pixels to be blended. The blending can be done in any domain, including the RGB or YCbCr domains, to mention two examples.

The multiplexer 34 selects either per pixel alpha values or alpha pipe values. The constant alpha value is basically a scaling ratio that can be used alone or with a per pixel alpha value. Usually a constant alpha is used for scaling the selected per pixel alpha value, but it is not used alone in some embodiments. When the selected per pixel alpha value is always a constant “1” (in that case, the pixel pipe or the alpha do not really have an alpha source), the scaled alpha value is actually the constant alpha value. In this sense, the constant alpha value looks like it is used alone. The resulting alpha value “a” may be used in the multiplier 38 or multiplier 40, as appropriate.

Alpha-blending is used to create a semi-transparent look. The color components of the prior stage picture pixels (output of multiplexer 32) are multiplied by 1-alpha and added with this pipe's color (normally pre-multiplied with alpha) in one embodiment. When alpha=0, the new pixel is completely transparent and therefore invisible in one embodiment. When alpha=1, this pipe's pixel is opaque and prior pixel is invisible in one example.

The alpha value used for blending may have two sources. The alpha value may come with pixels from the pixel pipe (PP input) which is the output of a Universal Pixel Plane (UPP). In this case, the content of every UPP output pixel includes an alpha value. As an example, for video format of ARGB8888, each pixel has 4 components: 8 bit alpha, 8 bit R, 8 bit G, 8 bit B. As another option, the alpha value may come from a separate alpha pipe (AP input) which is the output of an Alpha-Index plane (IAP). In this case, the content of every IAP output only has an alpha value. As an example, for ARIB standard, every output of the switching plane corresponds to a pixel position and a one bit alpha value is used to select a pixel either from a still picture or from the video plane (blending has only two effects: transparent and opaque). See Association of Radio Industries and Businesses, Video Coding, Audio Coding and Multiplexing Specifications for Digital Broadcasting (ARIB STD-B32) Ver. 2.1 (Mar. 14, 2007).

For both of these alpha value sources, the alpha value is pixel based, i.e., it changes pixel by pixel. Each pixel has its own alpha value. That is why it is called a per pixel alpha value.

A constant alpha value is a programmable constant and it is plane-based (coming from the attached plane, so it does not change for a specific plane). It is used to scale the selected alpha value from either of the alpha sources described above.

A pseudo code functional description for the embodiment of FIG. 3 is as follows:

//Inputs:
plane_pix; // current plane pixels( as an example, RGB components
of PP input)
plane_pp_alpha; // plane per pixel alpha (Alpha component of PP input)
lb_pix; // pixels from the left blender (LB)
rb_pix; // pixels from the right blender (RB)
alphapipe_pp_alpha; // per pixel alpha from the alpha pipe (AP)
const_alpha[7:0]; // a programmable constant
// Configuration bits
prev_src_pix_sel ; // to select between right and left blender pixels
pp_alpha_select; // to select the alpha value
scale_alpha; // whether to scale the alpha value with const alpha
plane_alphamult; // whether the plane pixels need to be multiplied with
alpha or not
Output [11:0] blend_result;
Function blend
// STEP 1: alpha handling
pp_alpha =pp_{—} alpha_select ?plane_pp_alpha : alphapipe_pp_alpha;
// multiplexer in multiplexer 34
// scale alpha
scaled_multiplier = const_alpha*pp_alpha; // multiplier in 34
// whether to scale alpha or not
effective_alpha = scale_alpha ? scaled_multiplier : pp_alpha; // 34
// STEP 2 : for attached plane (PP input)
plane_blend_result = plane_alpha_mult ? (effective_alpha *
plane_pix) : plane_pix; //
38 then 36
// STEP 3 : for previous stage
prev_pxl = (prev_src_pix_sel ==LB)? lb_pix:rb_pix; // 32
prev_plane_blend_result = (1− effective_alpha) * prev_pxl; // 42
then 40
// STEP 4 : blend together
blend_result = plane_blend_result + prev_plane_blend_result; // 44

The multiplexer 34 in FIG. 3 actually may have three functions in one embodiment:

(1) it selects an alpha value from either of the per pixel alpha (PP) or alpha pipe (AP);

(2) it scales the result of (1) above with a constant alpha; and/or

(3) it selects whether to apply scaling or not.

Thus, an alpha value can come from three different sources: a per pixel alpha from the attached plane, a constant alpha, or a per pixel output from a separate alpha plane. In addition, if either of the per pixel alpha sources is selected, there is an additional option to scale with that constant alpha value. The selected alpha value is then used in the blending operation. For the current plane pixels, optionally, the alpha value is not multiplied, it is assumed that the pixels are pre-multiplied. The previous source pixel is always multiplied by alpha value 1 (should be 1-alpha).

The configuration shown in FIG. 2 can achieve a blending effect comparable to that set forth in the ARIB standard. In this case, UPM1, UPP0, UPP1, UPP2, and UPP3 are configured as ARID video source 1 (VP1), ARID still picture source (SP), ARIB video source 2 (VP2), text and graphics planes, and subtitled planes, respectively, while IAP0 and IAP1 are configured as a switching plane and cursor plane, respectively. VP1 (UPPM1) is blended with canvas (CColor0) in blend stage 24a and its output will then be sent to blend stage 24b for blending with SP (UPP0) based on the switching plane bit of IAP0. The output of the blend stage 24b is also sent to blend stage 24g for blending with VP2 (UPP1). Later text or graphics planes, subtitle planes, and cursor planes may be blended in the remaining blend stages 24c, 24d, and 24f.

Through the use of a flexible blender architecture, a variety of applications, including high definition (HD) DVD and Direct TV® satellite broadcasting, can be supported in some embodiments. The seven blend stages 24 can be partitioned into two separate data paths to support two simultaneous display outputs, indicated as TG0 and TG1 in one embodiment. A flexible number of planes can be assigned to these paths to get different effects.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
blending a plurality of video data signals for a video display using a plurality of identical hardware blend stages.

2. The method of claim 1 including providing at least two different output windows for said video display.

3. The method of claim 2 enabling different video planes to be assigned to either of said output pipes.

4. The method of claim 1 including providing a first input in the form of a universal pixel plane including video or graphics and a second input including subtitle, cursor, or alpha content, and blending said first and second inputs.

5. The method of claim 1 including selectively blending two of at least three input planes.

6. The method of claim 5 including selecting at least one of two different alpha value sources.

7. The method of claim 6 including providing an option to selectively use a constant alpha value source.

8. The method of claim 1 including providing at least three video planes and enabling the selection of two of said three planes for blending.

9. The method of claim 8 including enabling selective application of an alpha value to a video plane.

10. The method of claim 9 wherein said alpha value is applied depending on whether or not the alpha value has been previously applied to the input plane.

11. An apparatus comprising:
a plurality of identical blend stages, each stage including at least a first input for video and graphics and a second input for subtitle, cursor, or alpha content; and
a multiplier to selectively multiply a pixel value by an alpha value.

12. The apparatus of claim 11 wherein at least one of said blend stages to receive at least two different alpha value inputs.

13. The apparatus of claim 11, said apparatus to provide two separate output windows for a video display.

14. The apparatus of claim 11, said blend stages to selectively blend two of at least three input video planes.

15. The apparatus of claim 11 including a multiplier to selectively blend one of a per pixel alpha value or an alpha pipe value.

16. The apparatus of claim 11 including a multiplier to use a per pixel value alone or with a constant alpha value.

17. The apparatus of claim 11, said multiplier to apply said alpha value if said alpha value has not already been applied to a video plane.

18. The apparatus of claim 11 including at least seven blend stages.

19. The apparatus of claim 18 wherein each blend stage is coupled to at least one other blend stage and at least one blend stage is coupled to at least two other blend stages.

20. The apparatus of claim 11 including a pair of multiplexers to selectively couple blenders to a first or a second video display window.
